(19) United States
(12) Patent Application Publication
(10) Pub. No.: US 2025/0293279 A1
(43) Pub. Date: Sep. 18, 2025

(54) MEMBRANE ELECTRODE ASSEMBLY

(71) Applicant: GM Global Technology Operations LLC, Detroit, MI (US)

(72) Inventors: Ruichun Jiang, Troy, MI (US); Swaminatha P. Kumaraguru, Rochester Hills, MI (US); Craig S. Gittleman, West Bloomfield, MI (US)

(73) Assignee: GM Global Technology Operations LLC, Detroit, MI (US)

(21) Appl. No.: 18/604,147

(22) Filed: Mar. 13, 2024

(51) Int. Cl. H01M 8/1051; C25B 1/04; H01M 4/90; H01M 8/1004

(52) U.S. Cl. CPC H01M 8/1051; C25B 1/04; H01M 4/9016; H01M 8/1004; H01M 2250/20

(57) ABSTRACT

A membrane electrode assembly includes a cathode portion including a cathode electrode and an anode portion disposed opposite the cathode portion and including an anode electrode. Additionally, the membrane electrode assembly includes a polymer electrolyte membrane extending between the cathode portion and the anode portion. Moreover, the membrane electrode assembly includes one or more metal oxides disposed therein with the metal oxides configured to react with hydrogen peroxide within the membrane electrode assembly. Additionally, the membrane electrode assembly includes one or more metal cations disposed therein with the metal cations configured to react with hydroxyl radicals disposed within the membrane electrode assembly.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a membrane electrode assembly for use within a fuel cell or an electrolyzer.

Membrane electrode assemblies are often used in electrolyzers and fuel cells to assist in splitting water molecules and/or producing electricity or hydrogen fuel. More specifically, electrolyzers split water molecules into oxygen and hydrogen using electrical energy, while fuel cells convert the chemical energy of a fuel (often hydrogen) and an oxidizing agent (often oxygen) into electricity through a pair of redox reactions.

During the chemical processes of electrolyzers and/or fuel cells, undesirable by-products are often produced such as hydrogen peroxide and hydroxyl radicals, which may cause degradation of the membrane electrode assembly. As such, a membrane electrode assembly which minimizes the effects of these undesirable by-products is desired.

### SUMMARY

In one configuration, a membrane electrode assembly, includes a cathode portion including a cathode electrode and an anode portion disposed opposite the cathode portion and including an anode electrode. Additionally, the membrane electrode assembly includes a polymer electrolyte membrane extending between the cathode portion and the anode portion. Moreover, the membrane electrode assembly includes one or more metal oxides disposed therein with the metal oxides configured to react with hydrogen peroxide within the membrane electrode assembly. Additionally, the membrane electrode assembly includes one or more metal cations disposed therein with the metal cations configured to react with hydroxyl radicals within the membrane electrode assembly.

The membrane electrode assembly may also include one or more of the following optional features. For example, the metal oxide may include one or more of Cerium Oxide, Cerium Zirconium Oxide, Zirconium Dioxide or Manganese Dioxide. Additionally, the metal cation may include one or more of Cerium (3+) or Manganese (2+). The metal oxide particles and metal cations may be disposed in the polymer electrolyte membrane. Moreover, the metal oxides may be disposed in the anode portion or adjacent to the anode portion and are configured to be gradually released into the polymer electrolyte membrane. Additionally, the metal oxides may be disposed in the cathode portion or adjacent to the cathode portion and are configured to be gradually released into the polymer electrolyte membrane. The gradual release of metal cations into the membrane prevents depletion of cations due to in-plane redistribution during operation and can also lead to a reduced amount of metal cations used at beginning of life minimizing voltage loss due to cation exchange. Further, an electrolyzer may incorporate the membrane electrode assembly. In another example, a fuel cell may incorporate the membrane electrode assembly. Additionally, a vehicle may incorporate the fuel cell.

In another configuration, an electrolyzer, configured to use an electric current to split water molecules into hydrogen and oxygen gases, includes a membrane electrode assembly including a cathode portion including a cathode electrode and an anode portion disposed opposite the cathode portion and including an anode electrode. Additionally, the membrane electrode assembly includes a polymer electrolyte membrane extending between the cathode portion and the anode portion. The cathode portion is supported by a gas diffusion layer and the anode portion is supported by a porous transport layer. Both adjacent layers facilitate gas and fluid transport. Additionally, the electrolyzer includes a water tank coupled to the membrane electrode assembly and configured to supply water to the anode portion, a power source coupled to the membrane electrode assembly and configured to supply electricity to the membrane electrode assembly, and a hydrogen tank configured to collect hydrogen gas formed within the membrane electrode assembly. Additionally, the membrane electrode assembly includes one or more metal oxides disposed adjacent to the cathode portion and configured to react with hydrogen peroxide formed near the cathode portion. Further, the membrane electrode assembly includes one or more metal cations disposed therein and configured to react with hydroxyl radicals disposed within the polymer electrolyte membrane.

The electrolyzer may also include one or more of the following optional features. For example, the metal oxide may include one or more of Cerium Oxide. Cerium Zirconium Oxide. Zirconium Dioxide or Manganese Dioxide. Additionally, the metal cation may include one or more of Cerium (3+) or Manganese (2+). The metal oxide particles and metal cations may be disposed in the polymer electrolyte membrane. Further, the metal oxides may be disposed in the cathode portion or adjacent to the cathode portion and are configured to be gradually released into the polymer electrolyte membrane. Additionally, the metal cations may be disposed throughout the polymer electrolyte membrane using liquid dispersion. Moreover, the polymer electrolyte membrane further includes one or more gas recombination catalysts disposed therein.

In yet another configuration, a fuel cell includes a membrane electrode assembly including a cathode portion including a cathode electrode and an anode portion disposed opposite the cathode portion and including an anode electrode. The membrane electrode assembly also includes a polymer electrolyte membrane extending between the cathode portion and the anode portion. Further, the fuel cell includes a fuel tank coupled to the membrane electrode assembly and configured to supply fuel to the anode portion and an oxygen source coupled to the membrane electrode assembly and configured to supply oxygen to the cathode portion. Additionally, the membrane electrode assembly includes one or more metal oxides disposed adjacent to the anode portion and configured to react with hydrogen peroxide formed near the anode portion. Moreover, the membrane electrode assembly includes one or more metal cations disposed therein and configured to react with hydroxyl radicals byproducts formed within the polymer electrolyte membrane.

The fuel cell may also include one or more of the following optional features. For example, the metal oxide may include one or more of Cerium Oxide, Cerium Zirconium Oxide, Zirconium Dioxide or Manganese Dioxide. Additionally, the metal cation may include one or more of Cerium (3+) or Manganese (2+). The metal oxide particles and metal cations may be disposed in the polymer electrolyte membrane. Moreover, the metal oxides may be disposed in the anode portion or adjacent to the anode portion and are configured to be gradually released into the polymer electrolyte membrane. Further, the polymer electrolyte membrane may further include one or more gas recombination catalysts disposed therein. Additionally, a vehicle may incorporate the fuel cell.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle including a fuel cell according to the present disclosure;

FIG. 2 is a schematic view of a fuel cell according to the present disclosure;

FIG. 3 is a schematic view of an electrolyzer according to another example of the present disclosure;

FIG. 4 is a schematic view of a membrane electrode assembly incorporating the fuel cell and electrolyzer of FIG. 2 and FIG. 3; and

FIG. 5 is a graphical illustration of Fluoride Release Rates for various polymer electrolyte membranes used with the fuel cell of FIG. 2.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to.” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks: magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

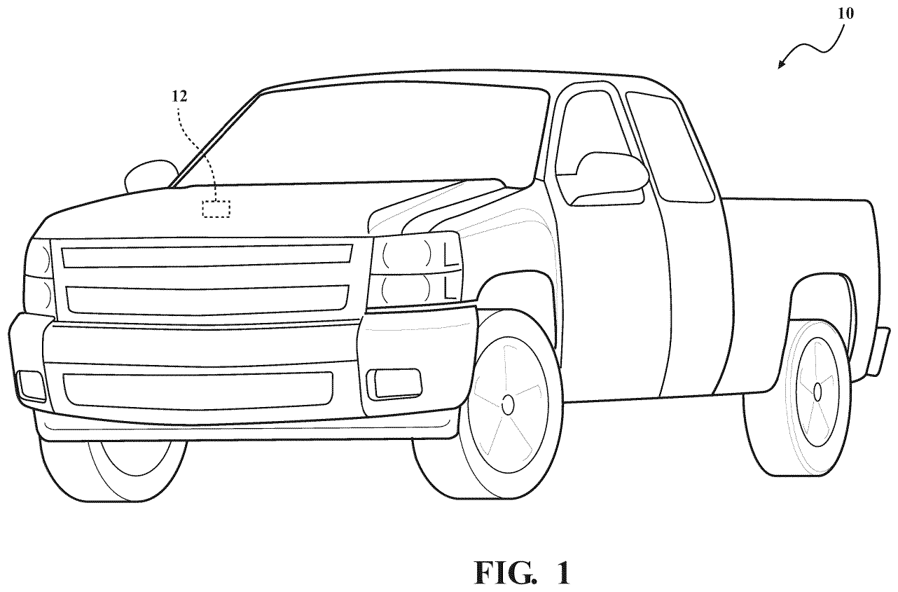

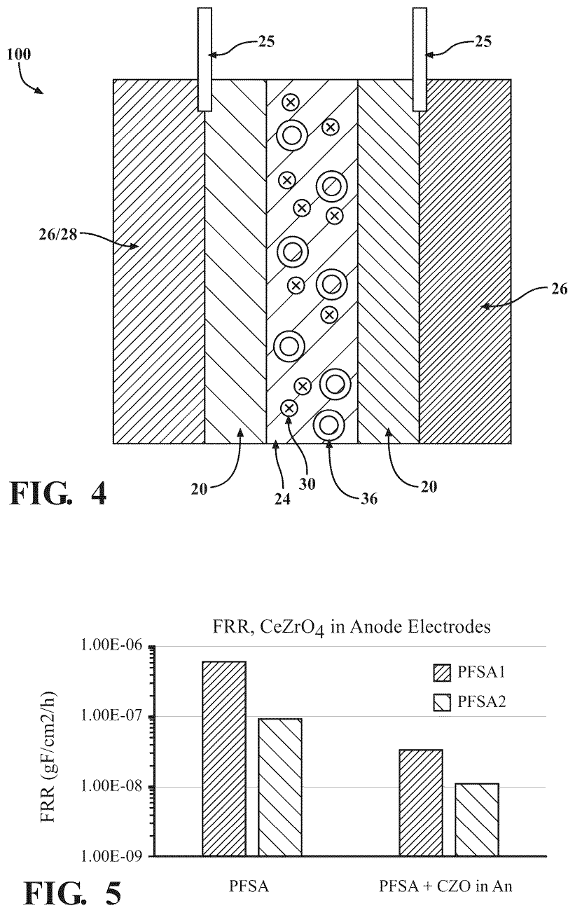

Referring to FIGS. 1-5, a membrane electrode assembly 100 is disclosed. The membrane electrode assembly 100, in one example, is located within a fuel cell 12, and is configured to convert the chemical energy of a fuel (often hydrogen) and an oxidizing agent (often oxygen) into electricity through a pair of redox reactions. The fuel cell 12 may be incorporated into a vehicle 10, as illustrated in FIG. 1. More specifically, the vehicle 10 may be an electric vehicle such that it is powered by the fuel cell 12 and may include autonomous or semi-autonomous capabilities. Alternatively, the vehicle 10 may be a hybrid electric vehicle, which may incorporate battery and/or fuel cell 12 components and capabilities.

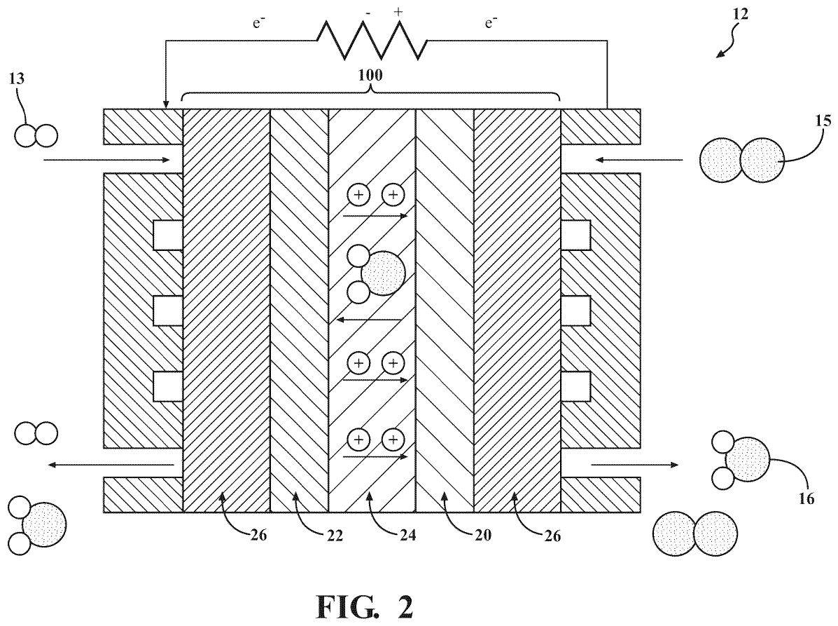

Additionally, the fuel cell 12, as shown in FIG. 2 may include a fuel source 13, such a hydrogen, and an oxygen source 15, such as ambient air. More specifically, the fuel from the fuel source 13 enters the fuel cell 12 where it is split into electrons and protons. The electrons are moved through a circuit, generating an electric current which may be used to power the vehicle 10 or to power another application such as an appliance. At an opposite end of the fuel cell 12, the protons, electrons, and oxygen from ambient air combine to produce water molecules.

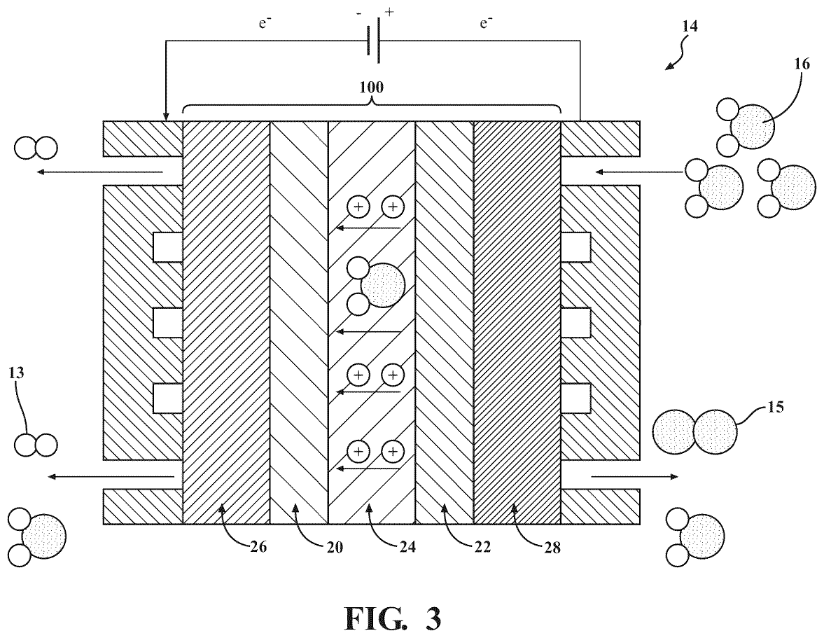

Referring now to the example shown in FIG. 3, the membrane electrode assembly 100 may alternatively be incorporated into an electrolyzer 14. In some examples, the electrolyzer 14 may include a water source 16, and a power source coupled to the membrane electrode assembly 100. More specifically, the membrane electrode assembly 100 uses electricity from the power source to split water entering the membrane electrode assembly 100 from the water source 16 into oxygen 15 and hydrogen 13, which is then stored in a hydrogen tank. Further, the stored hydrogen may then be used in other applications requiring hydrogen fuel, such as the fuel cell 12, as described above.

Regardless of whether the membrane electrode assembly 100 is incorporated within the fuel cell 12, the electrolyzer 14, or another system, the membrane electrode assembly 100 includes a cathode portion 20 disposed on one end and an anode portion 22 disposed on an opposite end from the cathode portion 20. In the electrolyzer 14 configuration, the cathode portion 20 includes a negatively charged porous electrode by which electrons enter the membrane electrode assembly 100 and within which a hydrogen evolution reaction occurs (within the electrolyzer 14), i.e. a chemical reaction which yields hydrogen. Additionally, the anode portion 22 includes a positively charged porous electrode in which the water is oxidized to evolve oxygen and the protons and electrons leave the electrode. Protons migrate across the polymer electrolyte membrane 24 to reach the cathode electrode 20, and electrons by external circuit. Adjacent to the cathode and anode electrode are layers of porous substrates that facilitate gas and fluid transport—namely gas diffusion layers 26. The gas diffusion lavers 26 may be made of nonwoven carbon paper and in some cases consist of a carbon layer named microporous layers (MPL). Additionally, in the electrolyzer 14 configuration, the gas diffusion layer 26 disposed adjacent to the anode portion 22 may be made of corrosion resistant material such as titanium oxide and is typically referred to as a porous transport layer 28.

As shown in FIGS. 2-4, a polymer electrolyte membrane 24 is disposed between the cathode portion 20 and the anode portion 22. Generally, the polymer electrolyte membrane 24 may be comprised of a fluoropolymer proton permeable electrical insulator barrier. Alternatively, the polymer electrolyte membrane 24 may be a hydrocarbon proton permeable electrical insulator barrier. The polymer electrolyte membrane 24 serves as a conductor for protons generated at the anode portion 22 to transport to the cathode portion 20 as a reactant for the hydrogen evolution reaction in the electrolyzer 14 or the oxygen reduction reaction in the fuel cell 12. Additionally, the polymer electrolyte membrane 24 also serves as an insulator for electrons to flow through an external circuit. Moreover, the polymer electrolyte membrane 24 may be comprised of a perfluorsulfonic acid ionomer.

Further, in the electrolyzer 14, the polymer electrolyte membrane 24 may further include one or more gas recombination catalysts (e.g., platinum, palladium either as standalone nanoparticles, or nanoparticles on supports like carbon, SiO₂, and the like) disposed therein to prevent hydrogen and oxygen cross over as gases across the polymer electrolyte membrane 24. In the example including the electrolyzer 14, the gas recombination catalysts are configured to combine hydrogen and oxygen within the membrane 24 to prevent hydrogen from getting into the oxygen product stream. Similarly, in the fuel cell 12, the gas recombination catalysts are configured prevent crossover of gases across the polymer electrolyte membrane 24. For improved mechanical robustness, in addition to a proton conducting polymer, the polymer electrolyte membrane could be reinforced with mechanical supports such as expanded polyterafluoroethylene (ePTFE) or electrospun polymeric fibers, and the like.

Additionally, during the hydrogen evolution reaction and/or the oxygen evolution reaction in the electrolyzer 14 or the hydrogen oxidation and/or oxygen reduction reactions in the fuel cell 12, by-products may be formed such as hydrogen peroxide (H₂O₂) and/or hydroxyl radicals (·OH). These by-products are highly reactive chemicals that may contribute to degradation of the polymer electrolyte membrane 24 if left in their reactive form.

To prevent this degradation, the membrane electrode assembly 100 includes one or more metal oxides 30 disposed therein and configured to react with hydrogen peroxide within the polymer electrolyte membrane 24. The metal oxide 30 includes, but is not limited to, one or more of Cerium Oxide, Cerium Zirconium Oxide, Zirconium Dioxide or Manganese Dioxide. Further, the metal oxides 30 may in the form of one or more of CeEOx, MnEOx, and/or CoEOx (with E designating a metal element). Additionally, the metal oxides 30 may be disposed within the membrane electrode assembly 100 such as within the membrane 24, anode or cathode gas diffusion layers (GDLs) 26 or porous transport layers (PTLs) 28 and/or may also be disposed within the anode portion 22 or the cathode portion 20 such as within electrodes, within anode or cathode sub-gaskets 25, or within adhesives configured to secure components of the membrane electrode assembly 100.

Additionally, the metal oxides 30 may be comprised of relatively large particles. which allows for separation within the polymer electrolyte membrane 24. In one example, the polymer electrolyte membrane 24 may include about 0.01 weight percent to about 50 weight percent of the metal oxide 30. In other examples, the polymer electrolyte membrane 24 may include about 1 weight percent to about 45 weight percent of the metal oxide 30. In still other examples, the polymer electrolyte membrane 24 may include about 5 weight percent to about 40 weight percent of the metal oxide 30.

Moreover, the metal oxides 30 may be concentrated near the portion of the membrane electrode assembly 100 where the hydrogen peroxide is formed. For example, in the case of the fuel cell 12, as shown in FIG. 2, hydrogen peroxide is typically formed near the anode portion 22 of the membrane electrode assembly 100. Alternatively, in the case of an electrolyzer 14, as shown in FIG. 3, hydrogen peroxide is typically formed near the cathode portion 20 of the membrane electrode assembly 100. As such, in the case of the fuel cell 12, the metal oxide 30 may be concentrated near the anode portion 22 such that the hydrogen peroxide can react with the metal oxides 30 immediately upon or soon after formation in the anode portion 22. Moreover, in the case of the electrolyzer 14, the metal oxide 30 may be concentrated near the cathode portion 20 such that the hydrogen peroxide can react with the metal oxides 30 immediately upon or soon after formation in the cathode portion 20.

The membrane electrode assembly 100 also includes a plurality of metal cations 36 to help combat degradation of the polymer electrolyte membrane 24 due to formation of hydroxyl radicals as a by-product. The metal cations 36 may include, but are not limited to. Cerium (3+) or Manganese (2+). The metal cations 36 may be disposed within the polymer electrolyte membrane 24, and/or within the anode 22 or cathode 20 electrode, and/or other components such as within anode or cathode micro porous layers (MPLs), anode or cathode gas diffusion layers (GDLs) 26, or porous transport layers (PTLs) 28 and/or may also be disposed within the anode portion 22 or the cathode portion 20 such as within the electrodes, within anode or cathode sub-gaskets 25, or within adhesives configured to secure components of the membrane electrode assembly 100.

Additionally, in one example, the polymer electrolyte membrane 24 may include about 0.01 weight percent to about 50 weight percent of the metal cations 36. In other examples, the polymer electrolyte membrane 24 may include about 1 weight percent to about 45 weight percent of the metal cations 36. In still other examples, the polymer electrolyte membrane 24 may include about 5 weight percent to about 40 weight percent of the metal cations 36.

Additionally, the metal cations 36 may be introduced to the membrane electrode assembly 100 in the form of metal salts such that the metal cations 36 are introduced into the polymer electrolyte membrane in solid form. Moreover, the metal salts may be disposed throughout the polymer electrolyte membrane 24 using dispersion or another distribution technique.

Additionally, to ensure constant and gradual release of the metal cations 36, the metal oxides 30 and/or the metal cations 36 may be disposed in layers adjacent to the desired input location and configured to be gradually released into the polymer electrolyte membrane 24. For example, in the fuel cell 12 example shown in FIG. 2, the metal oxides 30 and/or the metal cations 36 may optionally be disposed in the cathode portion 20 or gas diffusion layer 26 and are configured to be gradually released into the polymer electrolyte membrane 24. Additionally, in the electrolyzer 14 example shown in FIG. 3, the metal oxides 30 and/or the metal cations 36 may be optionally disposed in the anode portion 22 or the porous transport layer 28 and are configured to be gradually released into the polymer electrolyte membrane 24. Additionally, the metal oxides 30 and/or the metal cations 36 may be stored within components of the membrane electrode assembly 100 such as within the membrane 24, anode or cathode micro porous layers (MPLs), anode or cathode gas diffusion layers (GDLs) or porous transport layers (PTLs) and/or may also be disposed within the anode portion 22 or the cathode portion 20 such as within electrodes, within anode or cathode sub-gaskets 25, or within adhesives configured to secure components of the membrane electrode assembly 100.

By adding a combination of metal oxides 30 and metal cations 36 into the polymer electrolyte membrane 24, undesired by-products occurring in the membrane electrode assembly 100 are significantly reduced. Additionally, by utilizing metal oxides 30 at the source location of the by-product (e.g, hydrogen peroxide (H₂O₂)), harmful by-products can be effectively reduced prior to causing degradation to the polymer electrolyte membrane 24. Moreover, by also including the dispersed metal cations 36 within the polymer electrolyte membrane 24, potential radicals such as hydroxyl radicals are also neutralized preventing polymer electrolyte membrane 24 degradation. As such, a membrane electrode assembly 100 having longer life is disclosed herein.

### EXAMPLES

The following example is illustrative of exemplary configurations of the disclosure. In these examples, as well as elsewhere in this application, all ratios, parts, and percentages are by weight unless otherwise indicated. It is intended that these examples are being presented for the purpose of illustration only and are not intended to limit the scope of the concepts disclosed herein.

For example, FIG. 5 illustrates the membrane chemical durability of two-fuel cell membrane electrode assemblies with perfluorosulfonic acid (PFSA) membranes (PFSA1 and PFSA 2), with and without the additive CeZrO4 in the anode electrodes. As illustrated in the graph, the membrane electrode assembly including CeZrO4 in an anode electrode has a lower fluoride release rate (FRR) which leads to increased membrane chemical durability of the membrane.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A membrane electrode assembly comprising:
a cathode portion including a cathode electrode;
an anode portion disposed opposite the cathode portion and including an anode electrode; and
a polymer electrolyte membrane extending between the cathode portion and the anode portion,
wherein the membrane electrode assembly includes one or more metal oxides disposed therein and configured to react with hydrogen peroxide within the membrane electrode assembly and wherein the membrane electrode assembly includes one or more metal cations disposed therein and configured to react with hydroxyl radicals disposed within the membrane electrode assembly.

2. The membrane electrode assembly of claim 1, wherein the metal oxide includes one or more of Cerium Oxide, Cerium Zirconium Oxide, Zirconium Dioxide or Manganese Dioxide and the metal cation includes one or more of Cerium (3+) or Manganese (2+).

3. The membrane electrode assembly of claim 1, wherein the metal cation and the metal oxide are disposed in the polymer electrolyte membrane.

4. The membrane electrode assembly of claim 1, wherein metals forming one or more of the metal oxides or the metal cations are disposed in the anode portion or in layers adjacent to the anode portion and are configured to be gradually released into the polymer electrolyte membrane.

5. The membrane electrode assembly of claim 1, wherein metals forming one or more of the metal oxides or the metal cations are disposed in the cathode portion or in layers adjacent to the cathode portion and are configured to be gradually released into the polymer electrolyte membrane.

6. An electrolyzer incorporating the membrane electrode assembly of claim 1.

7. A fuel cell incorporating the membrane electrode assembly of claim 1.

8. A vehicle incorporating the fuel cell of claim 7.

9. An electrolyzer configured to use an electric current to split water molecules into hydrogen and oxygen gases, the electrolyzer comprising:
a membrane electrode assembly including;
a cathode portion including a cathode electrode;
an anode portion disposed opposite the cathode portion and including an anode electrode; and
a polymer electrolyte membrane extending between the cathode portion and the anode portion;
a water tank coupled to the membrane electrode assembly and configured to supply water to the anode portion;
a power source coupled to the membrane electrode assembly and configured to supply electricity to the membrane electrode assembly; and
a hydrogen tank configured to collect hydrogen gas formed within the cathode portion of the membrane electrode assembly,
wherein the membrane electrode assembly includes one or more metal oxides disposed adjacent to the cathode portion and configured to react with hydrogen peroxide formed near the cathode portion and wherein the membrane electrode assembly includes one or more metal cations disposed therein and configured to react with hydroxyl radicals disposed within the membrane electrode assembly.

10. The electrolyzer of claim 9, wherein the metal oxide includes one or more of Cerium Oxide, Cerium Zirconium Oxide, Zirconium Dioxide or Manganese Dioxide.

11. The electrolyzer of claim 9, wherein the metal cation includes one or more of Cerium (3+) or Manganese (2+).

12. The electrolyzer of claim 9, wherein metals forming one or more of the metal oxides or the metal cations are disposed in the cathode portion or layers adjacent to the cathode portion and are configured to be gradually released into the polymer electrolyte membrane

13. The electrolyzer of claim 9, wherein the metal cations and metal oxides are disposed throughout the polymer electrolyte membrane using liquid dispersion.

14. The electrolyzer of claim 9, wherein the polymer electrolyte membrane further includes one or more gas recombination catalysts disposed therein.

15. A fuel cell comprising:
a membrane electrode assembly including:
a cathode portion including a cathode electrode;
an anode portion disposed opposite the cathode portion and including an anode electrode; and
a polymer electrolyte membrane extending between the cathode portion and the anode portion;
a fuel tank coupled to the membrane electrode assembly and configured to supply fuel to the anode portion; and
an oxygen source coupled to the membrane electrode assembly and configured to supply oxygen to the cathode portion;
wherein the membrane electrode assembly includes one or more metal oxides disposed adjacent to the anode portion and configured to react with hydrogen peroxide formed near the anode portion and wherein the membrane electrode assembly includes one or more metal cations disposed therein and configured to react with hydroxyl radicals disposed within the membrane electrode assembly.

16. The fuel cell of claim 15, wherein the metal oxide includes one or more of Cerium Oxide, Cerium Zirconium Oxide, Zirconium Dioxide or Manganese Dioxide.

17. The fuel cell of claim 15, wherein the metal cation includes one or more of Cerium (3+) or Manganese (2+).

18. The fuel cell of claim 15, wherein metals forming one or more of the metal oxides or the metal cations are disposed in the anode portion or layers adjacent to the anode portion and are configured to be gradually released into the polymer electrolyte membrane.

19. The fuel cell of claim 15, wherein the metal cations and metal oxides are disposed throughout the polymer electrolyte membrane using liquid dispersion.

20. A vehicle incorporating the fuel cell of claim 15.
